(19) United States
(12) Patent Application Publication
(10) Pub. No.: US 2010/0046026 A1
(43) Pub. Date: Feb. 25, 2010

(54) IMAGE FORMING APPARATUS AND IMAGE FORMING METHOD

(75) Inventor: Nam HEO, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., LTD., Suwon-si (KR)

(21) Appl. No.: 12/469,989

(22) Filed: May 21, 2009

Related U.S. Application Data
(60) Provisional application No. 61/090,687, filed on Aug. 21, 2008.

(30) Foreign Application Priority Data
Oct. 31, 2008 (KR) 2008-107968

(51) Int. Cl. G06F 3/12

(52) U.S. Cl. 358/1.15

(57) ABSTRACT

An image forming method and image forming apparatus for printing a print data file provided from an external device such as a cellular phone or a universal serial bus (USB) memory device. The image forming apparatus displays the print data file, sets a print profile of the print data file based on a user's input, prints the print data file based on the print profile, and shares the print profile with the external device.

### CROSS-REFERENCE TO RELATED APPLICATION

This application claims the benefit of U.S. Provisional Application No. 61/090,687, filed Aug. 21, 2008, in the U.S. Patent and Trademark Office, and the benefit of Korean Application No. 2008-107968, filed Oct. 31, 2008 in the Korean Intellectual Property Office, the disclosures of which are incorporated herein by reference.

### BACKGROUND OF THE INVENTION

1. Field of the Invention

Aspects of the present general inventive concept relate to an image forming apparatus such as a printer, and more particularly, to an image forming method and image forming apparatus for printing a print data file provided without using a personal computer (PC).

2. Description of the Related Art

External devices such as mobile devices (e.g., cellular phones and personal digital assistants (PDAs)) or memory devices (e.g., universal serial bus (USB) memory devices and external hard disks) can store a print data file such as a document file or an image file, and a user may want to directly print such a print data file stored in an external device by using an image forming apparatus.

Also, the user may want to print the print data file based on a specific print profile. However, in this case, unlike a case when a print instruction is provided to the image forming apparatus by using a personal computer (PC), the user cannot obtain a print corresponding to a user desired print profile. Although the user can realize the desired print profile by setting the print profile by using the PC when the print instruction is provided by using the PC, the print profile cannot be directly set by using the external device and the image forming apparatus does not have a function for setting a print profile. Thus, the image forming apparatus cannot print the print data file stored in the external device based on the user desired print profile.

### SUMMARY OF THE INVENTION

Aspects of the present general inventive concept provide an image forming apparatus capable of printing a print data file provided from an external device that does not have a function for setting a print profile, based on a user desired print profile.

According to an aspect of the present general inventive concept, there is provided an image forming apparatus which is connectable to an external device and is capable of printing print data provided from the external device, the apparatus including a user interface for displaying the print data and setting print options of the print data based on a user's input; an image forming unit for printing the print data based on the print options; and a control unit for controlling operations of the user interface and the image forming unit.

The external device may store one or more print data files, and the user interface of the external device may display the one or more print data files, select at least one of the one or more print data files based on the user's input, and set print options of each of the at least one of the one or more print data files. The external device may be connected to the image forming apparatus by a wired and/or a wireless connection. The user interface may display a preview image of the print data.

The external device may be a mobile device including memory. Additionally, the mobile device may be a cellular phone, a personal digital assistant (PDA), or a portable multimedia player (PMP), a mobile personal computer or a digital camera having a fixed or a removable memory. Also, the mobile device may store the print options for each user and provide the print options to the image forming apparatus connected to the mobile device. On the other hand, the image forming apparatus may store the print options for each user and provide the print options to the mobile device connected to the image forming apparatus.

The external device may be a memory device. Additionally, the external device may be a universal serial bus (USB) memory device or an external hard disk. Also, the image forming apparatus may store the print options for each user and provide the print options to the memory device connected to the image forming apparatus.

The image forming apparatus may further include a storage unit for storing the print options for each user. Additionally, the storage unit may store the print options to match the print data and the control unit may provide the print option to the mobile device. Meanwhile, the user interface may display the print options for each user and select one of the print options based on the user's manipulation, and the image forming unit may print the print data based on the selected print option. Each of the print options may include information regarding at least one of ‘print range’, ‘number of copies’, ‘paper size’, ‘pages per sheet (N-up)’, ‘orientation’, ‘margins’ or a combination thereof. Here, the print data may be text data or image data.

Aspects of the present general inventive concept also provide an image forming method capable of printing a print data file provided from an external device that does not have a function for setting a print profile, based on a user desired print profile.

According to another aspect of the present general inventive concept, there is provided an image forming apparatus including a storage unit for storing one or more print options for each user; a user interface for displaying the one or more print options and selecting one of the one or more print options; and an image forming unit for printing print data based on the selected print option.

The image forming apparatus may provide the print options to a mobile device connected to the image forming apparatus. Additionally, the mobile device may provide the print options to another image forming apparatus. Also, the mobile device may be connected to the image forming apparatus by wire. The storage unit may store each of print data files which separately match the print options. Each of the print options may include information regarding at least one of ‘print range’, ‘number of copies’, ‘paper size’, ‘pages per sheet (N-up)’, ‘orientation’, ‘margins’ or a combination thereof.

According to another aspect of the present general inventive concept, there is provided an image forming method performed by an image forming apparatus which is connected to an external device and is capable of printing print data provided from the external device, the method including displaying the print data; setting print options of the print data based on a user's manipulation; and printing the print data based on the print options.

Aspects of the present general inventive concept also provide a computer-readable recording medium for storing a computer program for executing an image forming method capable of printing a print data file provided from an external device that does not have a function for setting a print profile, based on a user desired print profile.

According to another aspect of the present general inventive concept, there is provided an image forming method including displaying one or more print options which are previously set for each user; selecting one of the one or more print options; and printing print data based on the selected print option.

The image forming method may include providing the print options to a mobile device connected to an image forming apparatus which performs the image forming method. Additionally, the mobile device may provide the print options to another image forming apparatus and, the mobile device may be connected to the image forming apparatus by wire.

Meanwhile, the image forming apparatus may store each of print data files which separately match the print options. Meanwhile, each of the print options may include information regarding at least one of ‘print range’, ‘number of copies’, ‘paper size’, ‘pages per sheet (N-up)’, ‘orientation’, ‘margins’ or a combination thereof.

Aspects of the present general inventive concept also provide a computer-readable recording medium for storing a computer program to execute an image forming method capable of printing a print data file provided from an external device that does not have a function to set a print profile, based on a user desired print profile, the method includes displaying the print data; setting print options of the print data based on a user's manipulation; and printing the print data based on the print options.

According to another aspect of the present general inventive concept, there is provided an image forming method in an image forming apparatus which is connectable to a mobile device, the method including selecting a print data file from among one or more print data files stored in the mobile device; displaying one or more print profiles stored in the mobile device; selecting a print profile from among the displayed one or more print profiles; transmitting the selected print profile and the selected print data file to the image forming apparatus; and printing the transmitted print data file based on the transmitted print profile on the image forming apparatus. The one or more print profiles may be provided from the image forming apparatus to the mobile device. Here, the method may further include transmitting the selected print profile and the selected print data file from the mobile device to an other image forming apparatus; and printing the transmitted print data file based on the transmitted print profile by using the other image forming apparatus. Here, the mobile device may be connectable to the image forming apparatus by a wired and/or wireless connection. Here, the method may further include creating the one or more print profiles by using the image forming apparatus, the creating of the one or more print profiles may include setting one or more print profiles; and storing the one or more print profiles in the image forming apparatus, and the one or more print profiles may be provided to the mobile device. Here, each of the one or more print profiles may include information regarding at least one of ‘document related information’, ‘profile creation date’, ‘print range’, ‘number of copies’, ‘paper size’, ‘pages per sheet (N-up)’, ‘orientation’, ‘margins’ or a combination thereof. Here, the method may further include displaying the selected print profile on the mobile device.

According to another aspect of the present general inventive concept, there is provided a mobile device including a storage unit to store one or more print data files and one or more print profiles; a user interface to display the one or more print data files and the one or more print profiles, receive a selection selecting one of the one or more displayed print data files, and receive another selection selecting one of the displayed print profiles; and receive another selection a control unit to transmit the selected print data file and the selected print profile to an image forming apparatus, wherein the image forming apparatus prints the transmitted print data file based on the transmitted print profile.

According to another aspect of the present general inventive concept, there is provided an image forming method in an image forming apparatus which is connectable to a mobile device, the method including requesting the mobile device for a print profile stored on the mobile device; displaying one or more print profiles stored in the mobile device on the mobile device; selecting one of the one or more print profiles; transmitting the selected print profile to the image forming apparatus; and printing a print data file stored in the image forming apparatus based on the transmitted selected print profile.

The method may further include transmitting the selected print profile to another image forming apparatus; and printing a print data file stored in the other image forming apparatus based on the transmitted print profile on the other image forming apparatus. The mobile device may be connectable to the image forming apparatus by a wired and/or a wireless connection. Each of the one or more print profiles may include information regarding at least one of ‘document related information’, ‘profile creation date’, ‘print range’, ‘number of copies’, ‘paper size’, ‘pages per sheet (N-up)’, ‘orientation’, ‘margins’, or a combination thereof. The method may further include displaying the selected print profile on the mobile device.

According to another aspect of the present general inventive concept, there is provided a mobile device including a storage unit for storing one or more print profiles; a user interface for displaying at least some of the one or more print profiles and receiving a selection selecting one of the displayed print profiles; and a control unit for transmitting the selected print profile to an image forming apparatus, wherein the image forming apparatus prints a print data file stored in the image forming apparatus based on the transmitted print profile.

According to another aspect of the present general inventive concept, there is provided an image forming method in an image forming apparatus which is connectable to a mobile device, the method including selecting a print data file from among one or more print data files stored in the mobile device; transmitting to the image forming apparatus the selected print data file and a print profile corresponding to the selected print data file from among one or more print profiles stored in the mobile device; and printing the transmitted selected print data file based on the transmitted print profile.

The one or more print profiles may be provided from the image forming apparatus to the mobile device. The method may further include transmitting to another image forming apparatus the selected print data file and the print profile corresponding to the selected print data file; and printing the transmitted print data file based on the transmitted print profile by using the other image forming apparatus. The mobile device may be connectable to the image forming apparatus by a wired and/or a wireless connection. Each of the one or more print profiles may include information regarding at least one of ‘document related information’, ‘profile creation date’, ‘print range’, ‘number of copies’, ‘paper size’, ‘pages per sheet (N-up)’, ‘orientation’, ‘margins’ or a combination thereof. The method may further include displaying on the mobile device the print profile corresponding to the selected print data file and is stored in the mobile device.

According to another aspect of the present general inventive concept, there is provided a mobile device including a storage unit to store one or more print data files and one or more print profiles corresponding to the one or more print data files; a user interface to display the one or more print data files and selecting one of the one or more displayed print data files; and a control unit to transmit the selected print data file and a print profile corresponding to the selected print data file to an image forming apparatus, wherein the image forming apparatus prints the transmitted print data file based on the transmitted print profile.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an external device and an image forming apparatus, according to an embodiment of the present general inventive concept;

FIGS. 2 through 9 are screen images of a user interface illustrated in FIG. 1, according to embodiments of the present general inventive concept; and

FIG. 10 is a flowchart of an image forming method according to an embodiment of the present general inventive concept.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

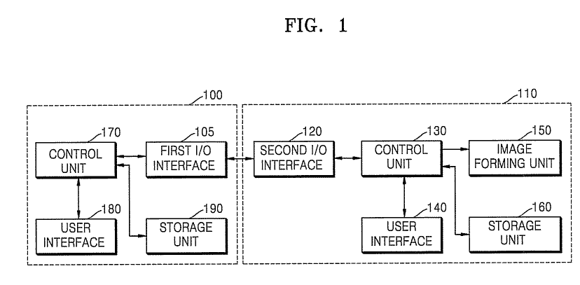

FIG. 1 is a block diagram of an external device 100 and an image forming apparatus 110, according to an embodiment of the present general inventive concept. Referring to FIG. 1, the external device 100 includes a first input/output (I/O) interface 105, and the image forming apparatus 110 includes a second I/O interface 120, a control unit 130, a user interface 140, an image forming unit 150, and a storage unit 160.

The external device 100 is any device that is connectable to the image forming apparatus 110 and stores one or more print data files. According to aspects of the present general inventive concept, a print data file is a data file that can be printed, such as a document file or an image file. In this example, the document file may be formed of only text, or text and an image.

The external device 100 may be a mobile device (including memory) such as a cellular phone, a personal digital assistant (PDA), or a portable multimedia player (PMP), or a memory device such as a universal serial bus (USB) memory device, an external hard disk, or other mobile devices such as a digital camera having a fixed or removable memory, etc. Moreover, the external device 100 can be a personal computer (PC), a laptop, a net-book or electronic book, or other such devices similar to a computer.

The image forming apparatus 110 is connected to the external device 100, wherein the external device 100 is a mobile device that communicates with the image forming apparatus 110, so that the image forming apparatus 110 receives the print data files from the external device 100 by a wired connection and/or by a wireless connection. In more detail, the control unit 130 of the image forming apparatus 110 requests the external device 100 for the print data files through the second I/O interface 120 and the external device 100 outputs the print data files to the second I/O interface 120 of the image forming apparatus 110 through the first I/O interface 105 as a response.

Meanwhile, although the external device 100 is a mobile device that can communicate with the image forming apparatus 110, if the external device 100 is directly connected to the image forming apparatus 110 by wire such as a cable, the control unit 130 recognizes the external device 100 as a memory device such as a USB memory device. In this example, the control unit 130 obtains the print data files from the external device 100 through the first and second I/O interfaces 105 and 120. Also, when the external device 100 is a memory device such as a USB memory device or an external hard disk, if the external device 100 is directly connected to the image forming apparatus 110 by wire such as a cable, the control unit 130 obtains the print data files from the external device 100 through the first and second I/O interfaces 105 and 120.

The control unit 130 of the image forming apparatus 110 controls the user interface 140 to display the print data files that are input through the second I/O interface 120. The user interface 140, which may be a touch panel or other similar display devices, has a display function and an input function and operates under the control of the control unit 130.

The user interface 140 displays the print data files provided form the external device 100, under the control of the control unit 130. The user interface 140 may display filenames of the print data files and while the user interface 140 displays the print data files, a user may manipulate the image forming apparatus 110 in order to select one of the print data files. If one of the print data files is selected, the user interface 140 may display a preview image of the selected print data file.

When one of the print data files is selected, the user interface 140 displays a window for setting a print profile of the selected print data file. According to aspects of the present general inventive concept, the print profile is information regarding one or more print options of a print data file. ‘Document related information’, ‘profile creation date’, ‘print range’, ‘number of copies’, ‘paper size’, ‘pages per sheet (N-up)’, ‘orientation’, ‘margins’ or a combination thereof, are examples of print options to be set as the print profile. ‘Document related information’ is information regarding a print data file and details of ‘document related information’ may vary. A ‘Profile creation date’ is a date when a print profile is created. ‘Print range’ is a range of a print data file to be printed and determining of whether to print, for example, all pages, a current page, selected pages, pages from a current page, or pages up to a current page of a print data file, is referred to as setting of ‘print range’. ‘Number of copies’ refers to the number of copies of the same page or pages to be printed. ‘Paper size’ is the size of paper on which a print data file is to be printed and determining whether to print a print data file on paper of, for example, A4 size, A5 size, A3 size, B4 size, or B5 size is referred to as setting of ‘paper size’. ‘N-up’ is the number of pages of a print data file to be printed on one page of paper. For example, 2-up means that two pages of a print data file are to be printed on one page of paper, 4-up means that four pages of a print data file are to be printed on one page of paper, and 8-up means that eight pages of a print data file are to be printed on one page of paper. ‘Orientation’ refers to whether to print a print data file in a portrait direction or a landscape direction of paper. ‘Margins’ refers to edge margins of paper on which a print data file is to be printed.

The user manipulates the user interface 140 with reference to the window of the user interface 140 so as to set the print profile of the selected print data file to be printed by using the image forming apparatus 110.

After the user interface 140 sets the print profile, the control unit 130 controls the image forming unit 150 to print the print data file based on the print profile. Thus, the image forming unit 150 prints the print data file based on the print profile. The control unit 130 stores the print profile set by the user interface 140 with respect to the print data file, in the storage unit 160. The storage unit 160 may store the print profile by matching the print profile with the print data file or regardless of the print data file.

If the storage unit 160 stores the print profile by matching the print profile with the print data file, when the print data file is to be printed by using the image forming apparatus 110 again later, the image forming apparatus 110 may print the print data file based on the stored print profile without setting the print profile of the print data file again. For example, if a user of the external device 100 directly connects the external device 100 to the image forming apparatus 110 by wire in order to print a print data file stored in the external device 100, the control unit 130 checks whether a print profile that corresponding to the print data file exists in the storage unit 160. If the print profile corresponding to the print data file exists, the user interface 140 does not need to display a window for setting the print profile of the print data file and the image forming unit 150 prints the print data file based on the print profile corresponding to the print data file. In contrast, if the print profile corresponding to the print data file does not exist, the user interface 140 displays the window for setting the print profile of the print data file, the user sets the print profile of the print data file by manipulating the user interface 140 with reference to the window of the user interface 140, and the image forming unit 150 prints the print data file based on the print profile set by the user.

On the other hand, if the storage unit 160 stores the print profile regardless of the print data file, when the print data file or any other print data file is to be printed by using the image forming apparatus 110 later, the user interface 140 displays the print profile and displays another window for checking whether the user wants to print the print data file based on the displayed print profile. If the user instruction is to print the print data file based on the displayed print profile, the image forming unit 150 prints the print data file based on the displayed print profile. In other words, the storage unit 160 may store one or more print profiles.

In the present exemplary embodiment, the storage unit 160 may store one or more print profiles that match each print data file or each user. In the following description, for convenience of explanation, it is assumed that the storage unit 160 stores one or more print profiles that match each user.

Since the storage unit 160 may store a plurality of print profiles, when the user instructs the external device 100 to print a print data file be using the image forming apparatus 110, the image forming apparatus 110 checks whether a print profile corresponding to the user of the external device 100 is stored in the storage unit 160, instead of unconditionally displaying on the user interface 140 a window for setting a print profile of the print data file.

If the print profile corresponding to the user of the external device 100 is not stored in the storage unit 160, the user interface 140 displays the window for setting the print profile of the print data file (that is stored in the external device 100 and is desired to be printed, by the user), the user sets the print profile by manipulating the user interface 140 with reference to the window of the user interface 140, and the image forming unit 150 prints the print data file based on the print profile set by the user.

On the other hand, if one or more print profiles that match the user of the external device 100 are stored in the storage unit 160, the user interface 140 displays a list of the print profiles. If the user finds and selects a desired print profile on the list, the image forming unit 150 prints the print data file based on the selected print profile. In contrast, if the desired print profile does not exist on the list, the user interface 140 displays the window for setting the print profile of the print data file, the user sets the print profile by manipulating the user interface 140 with reference to the window of the user interface 140, and the image forming unit 150 prints the print data file based on the print profile set by the user.

Meanwhile, the print profiles stored in the storage unit 160 of the image forming apparatus 110 may be stored in the external device 100. In more detail, the control unit 130 may provide one or more print profiles that (match each user and) are stored in the storage unit 160 of a certain image forming apparatus 110, to the external device 100 connected to the certain image forming apparatus 110. In this example, the external device 100 may be a mobile device such as a cellular phone, a PDA, or a PMP, or a memory device such as a USB memory device or an external hard disk. The print profiles provided from the image forming apparatus 110 to the external device 100 may be print profiles of one user or of a plurality of users.

Also, a mobile device (e.g., a cellular phone, a PDA, or a PMP) which stores one or more print profiles provided by one image forming apparatus 110, may provide the print profiles to another image forming apparatus 110. In this example, the other image forming apparatus 110 stores the print profiles provided from the mobile device. Thus, although the user has never set a print profile by using the other image forming apparatus 110, the other image forming apparatus 110 may print a print data file based on a desired print profile of the user.

In the exemplary embodiments described below, the external device 100 may be a mobile device. In these exemplary embodiments, the external device 100 may include a control unit 170, a user interface 180, and a storage unit 190.

In the present exemplary embodiment, the image forming apparatus 110 creates and stores one or more print profiles based on the user's manipulation. Then, the image forming apparatus 110 provides the print profiles to the external device 100 and the external device 100 stores the print profiles. In other words, the storage unit 190 stores the print profiles provided from the image forming apparatus 110 and may store one or more print data files. The user interface 180 displays at least some of the print data files and the print profiles which are stored in the storage unit 190. Based on the user's manipulation, the user interface 180 selects one of the displayed print data files and selects one of the displayed print profiles. The user interface 180 displays the selected print profile and the control unit 170 transmits the selected print data file and the selected print profile to the image forming apparatus 110. The image forming apparatus 110 prints the transmitted print data file based on the transmitted print profile. The external device 100 may transmit the selected print data file and the selected print profile, which are stored in the storage unit 190, to another image forming apparatus 110 other than the image forming apparatus 110 that has provided the print profiles to the external device 100. The other image forming apparatus 110 prints the transmitted print data file based on the transmitted print profile. Meanwhile, the external device 100 may be connected to the image forming apparatus 110 by wire and/or wirelessly.

In another exemplary embodiment, the image forming apparatus 110 stores a print data file and the storage unit 190 of the external device 100 stores one or more print profiles. The image forming apparatus 110 requests the external device 100 for a print profile. The user interface 180 displays the print profiles stored in the storage unit 190 as a response and selects one of the print profiles based on the user's manipulation. The user interface 180 displays the selected print profile and the control unit 170 transmits the selected print profile to the image forming apparatus 110. The image forming apparatus 110 prints the print data file stored in the image forming apparatus 110 based on the transmitted print profile. The external device 100 may transmit the selected print profile stored in the storage unit 190 to another image forming apparatus 110 other than the image forming apparatus 110 that has requested the external device 100 for the print profile. The other image forming apparatus 110 may print a print data file stored in the other image forming apparatus 110 based on the transmitted print profile. Meanwhile, the external device 100 may be connected to the image forming apparatus 110 by wire and/or wirelessly.

In another exemplary embodiment, the image forming apparatus 110 creates and stores one or more print profiles based on the user's manipulation. Then, the image forming apparatus 110 provides the print profiles to the external device 100 and the external device 100 stores the print profiles. In other words, the storage unit 190 stores the print profiles provided from the image forming apparatus 110. The storage unit 190 also stores one or more print data files. In the present exemplary embodiment, the storage unit 190 stores the print data files and the print profiles by correspondingly matching the print data files with the print profiles. In other words, the storage unit 190 stores the print data files and also stores the print profiles that correspondingly match the print data files. Based on the user's input, the user interface 180 selects one of the print data files stored in the storage unit 190 and displays a print profile corresponding to the selected print data file and is stored in the storage unit 190. The control unit 170 transmits the selected print data file and the print profile corresponding to the selected print data file to the image forming apparatus 110. The image forming apparatus 110 prints the transmitted print data file based on the transmitted print profile. The external device 100 may transmit the selected print data file and the print profile corresponding to the selected print data file to another image forming apparatus 110 other than the image forming apparatus 110 that has provided the print profiles to the external device 100. The other image forming apparatus 110 prints the transmitted print data file based on the transmitted print profile. Meanwhile, the external device 100 may be connected to the image forming apparatus 110 by a wired and/or a wireless connection.

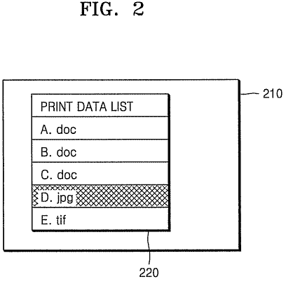

FIGS. 2 through 9 are screen images of the user interface 140 illustrated in FIG. 1, according to embodiments of the present general inventive concept. FIGS. 2 through 9 will be described in conjunction with FIG. 1. In FIGS. 2 through 9, a reference numeral 210 represents a screen included in the user interface 140. The screen may be implemented by using a liquid crystal display (LCD), or other display devices.

FIG. 2 shows an example of a window 220 displayed by the user interface 140 when the external device 100 that is connected to the image forming apparatus 110 provides a plurality of print data files including three document files such as A.doc, B.doc, and C.doc, and two image files such as D.jpg and E.tif to the image forming apparatus 110. As shown in FIG. 2, the user interface 140 may display filenames of the print data files (A.doc, B.doc, C.doc, D.jpg, E.tif. A user may select a desired print data file to be printed (D.jpg) from among the print data files. In this example, the selected print data file may be displayed so as to be identified from the other print data files.

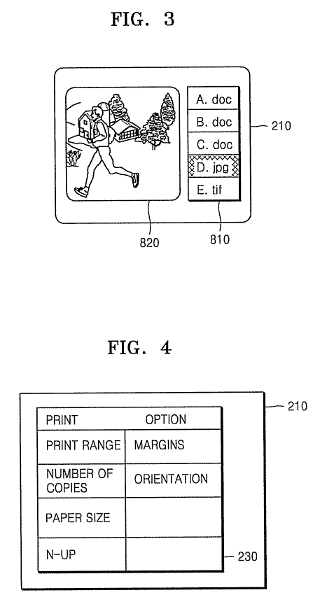

FIG. 3 shows an example of when a preview image of the selected print data file (D.jpg) is displayed. As shown in FIG. 3, the user interface 140 displays the print data files (A.doc, B.doc, C.doc, D.jpg, E.tif) on a window 810 that is smaller than the window 220 illustrated in FIG. 2. The user interface 140 also displays a window 820 for previewing the selected print data file (D.jpg). As such, the user may ultimately confirm whether the selected print data file is a file that the user wants to print.

FIGS. 4 through 8 show examples of windows displayed by the user interface 140 when the user wants to set a print profile of the selected print data file after the selected print data file is ultimately confirmed as described above with reference to FIGS. 2 and 3.

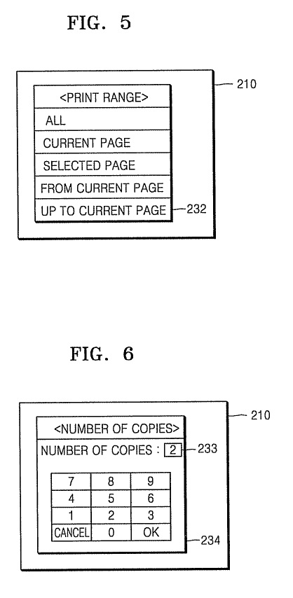

As shown in FIG. 4, the user interface 140 may display a window 230 showing print options such as ‘print range’, ‘number of copies’, ‘paper size’, ‘N-up’, ‘margins’, ‘orientation’, or a combination thereof. If the user selects ‘print range’ from among the print options illustrated in FIG. 4 by manipulating the user interface 140, the user interface 140 displays a window 232 illustrated in FIG. 5. In this example, if the user selects ‘all’, the image forming unit 150 prints all pages of the print data file. Likewise, if the user selects ‘current page’, the image forming unit 150 prints a current page of the print data file. If the user selects ‘selected pages’, the image forming unit 150 prints selected pages of the print data file. If the user selects ‘from current page’, the image forming unit 150 prints pages from a current page of the print data file. If the user selects ‘up to current page’, the image forming unit 150 prints pages up to a current page of the print data file.

If the user selects ‘number of copies’ from among the print options illustrated in FIG. 4 by manipulating the user interface 140, the user interface 140 displays a window 234 illustrated in FIG. 6. In this example, the user may set the number of copies by manipulating number keys on the window 234. The number of copies is set and displayed in a box 233.

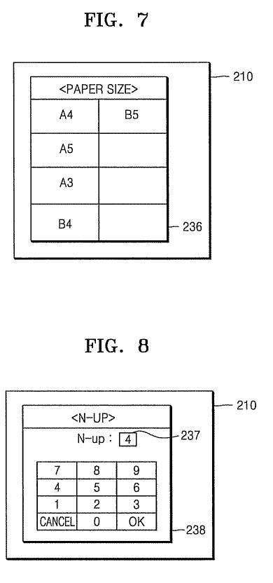

If the user selects ‘paper size’ from among the print options illustrated in FIG. 4 by manipulating the user interface 140, the user interface 140 displays a window 236 illustrated in FIG. 7. In this example, if the user selects ‘A4’, the image forming unit 150 prints the print data file on A4 sized paper. Likewise, if the user selects ‘A5’, the image forming unit 150 prints the print data file on A5 sized paper. If the user selects ‘A3’, the image forming unit 150 prints the print data file on A3 sized paper. If the user selects ‘B4’, the image forming unit 150 prints the print data file on B4 sized paper. If the user selects ‘B5’, the image forming unit 150 prints the print data file on B5 sized paper.

If the user selects ‘N-up’ from among the print options illustrated in FIG. 4 by manipulating the user interface 140, the user interface 140 displays a window 238 illustrated in FIG. 8. In this example, the user may set the number of pages of the print data file to be printed on one page of paper, by manipulating number keys on the window 238. The number of pages is set and displayed in a box 237.

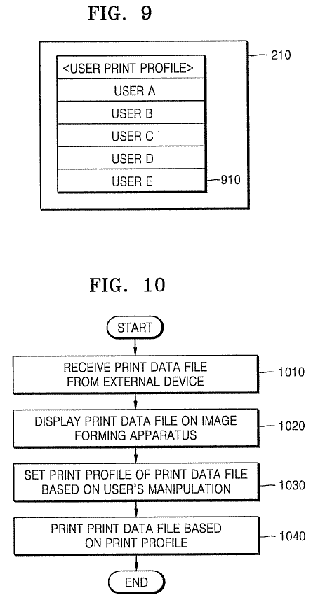

Meanwhile, as described above with reference to FIG. 1, the storage unit 160 of the image forming apparatus 110 may store one or more print profiles for each user. A user may manipulate the image forming apparatus 110 in order to view the stored print profiles. In this example, the user interface 140 may display a window 910 illustrated in FIG. 9. As shown in FIG. 9, the user interface 140 displays the window 910 showing five users such as ‘user a’, ‘user b’, ‘user c’, ‘user d’, and ‘user e’. In this example, if the user selects ‘user a’ by manipulating the user interface 140, the user interface 140 displays one or more print profiles that match user a and are stored in the storage unit 160. Likewise, if the user selects ‘user b’ by manipulating the user interface 140, the user interface 140 displays one or more print profiles that match user b and are stored in the storage unit 160. If the user selects ‘user c’ by manipulating the user interface 140, the user interface 140 displays one or more print profiles that match user c and are stored in the storage unit 160. If the user selects ‘user d’ by manipulating the user interface 140, the user interface 140 displays one or more print profiles that match user d and are stored in the storage unit 160. If the user selects ‘user e’ by manipulating the user interface 140, the user interface 140 displays one or more print profiles that match user e and are stored in the storage unit 160.

FIG. 10 is a flowchart of an image forming method in an image forming apparatus capable of printing a print data file provided from an external device that does not have a function for setting a print profile, based on a desired print profile of a user, according to an embodiment of the present general inventive concept. FIG. 10 will be described in conjunction with FIG. 1.

Referring to FIG. 10, the image forming apparatus 110 is connected to and receives a print data file from the external device 100 such as a mobile device or a memory device, in operation 1010.

The image forming apparatus 110 displays the print data file received in operation 1010, in operation 1020. For example, the image forming apparatus 110 may display a filename of the print data file.

A user manipulates the image forming apparatus 110 in order to set a print profile of the print data file that is displayed in operation 1020, and the image forming apparatus 110 sets the print profile of the print data file based on a manipulation result of the user, in operation 1030.

The image forming apparatus 110 prints the print data file based on the print profile that is set in operation 1030, in operation 1040.

A computer program for executing an image forming method according to the above embodiments of the present general inventive concept can be written in a computer-readable recording medium. Here, examples of the recording medium include magnetic storage media (e.g., ROM, floppy disks, hard disks, etc.) and optical recording media (e.g., CD-ROMs, or DVDs). Such programs can be implemented by one or more processors and/or computers.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming method in an image forming apparatus which is connectable to a mobile device, the method comprising:
selecting a print data file from among one or more print data files stored in the mobile device;
displaying one or more print profiles stored in the mobile device;
selecting a print profile from among the displayed one or more print profiles;
transmitting the selected print profile and the selected print data file to the image forming apparatus; and
printing the transmitted print data file based on the transmitted print profile on the image forming apparatus.

2. The method of claim 1, wherein the one or more print profiles are provided from the image forming apparatus to the mobile device.

3. The method of claim 1, further comprising:
transmitting the selected print profile and the selected print data file from the mobile device to another image forming apparatus; and
printing the transmitted print data file based on the transmitted print profile by using an other image forming apparatus.

4. The method of claim 1, wherein the mobile device is connectable to the image forming apparatus by a wired and/or a wireless connection.

5. The method of claim 1, further comprising creating the one or more print profiles by using the image forming apparatus,
wherein the creating of the one or more print profiles comprises:
setting one or more print profiles; and
storing the one or more print profiles in the image forming apparatus, and
wherein the one or more print profiles are provided to the mobile device.

6. The method of claim 1, wherein each of the one or more print profiles comprises information regarding at least one of ‘document related information’, ‘profile creation date’, ‘print range’, ‘number of copies’, ‘paper size’, ‘pages per sheet (N-up)’, ‘orientation’, ‘margins’, or a combination thereof.

7. The method of claim 1, further comprising displaying the selected print profile on the mobile device.

8. A mobile device comprising:
a storage unit to store one or more print data files and one or more print profiles;
a user interface to display the one or more print data files and the one or more print profiles, receiving a selection of selecting one of the displayed print data files, and receiving another selection selecting one of the one or more displayed print profiles; and
a control unit to transmit the selected print data file and the selected print profile to an image forming apparatus,
wherein the image forming apparatus prints the transmitted print data file based on the transmitted print profile.

9. An image forming method in an image forming apparatus which is connectable to a mobile device, the method comprising:
requesting the mobile device for a print profile stored on the mobile device;
displaying one or more print profiles stored in the mobile device on the mobile device;
selecting one of the one or more print profiles;
transmitting the selected print profile to the image forming apparatus; and
printing a print data file stored in the image forming apparatus based on the transmitted selected print profile.

10. The method of claim 9, further comprising:
transmitting the selected print profile to an other image forming apparatus; and
printing a print data file stored in the other image forming apparatus based on the transmitted print profile on the other image forming apparatus.

11. The method of claim 9, wherein the mobile device is connectable to the image forming apparatus by a wired and/or a wireless connection.

12. The method of claim 9, wherein each of the one or more print profiles comprises information regarding at least one of ‘document related information’, ‘profile creation date’, ‘print range’, ‘number of copies’, ‘paper size’, ‘pages per sheet (N-up)’, ‘orientation’, ‘margins’, or a combination thereof.

13. The method of claim 9, further comprising displaying the selected print profile on the mobile device.

14. A mobile device comprising:
a storage unit for storing one or more print profiles;
a user interface for displaying at least some of the one or more print profiles and to receive a selection selecting one of the displayed print profiles; and
a control unit for transmitting the selected print profile to an image forming apparatus,
wherein the image forming apparatus prints a print data file stored in the image forming apparatus based on the transmitted print profile.

15. An image forming method in an image forming apparatus which is connectable to a mobile device, the method comprising:
selecting a print data file from among one or more print data files stored in the mobile device;
transmitting to the image forming apparatus the selected print data file and a print profile corresponding to the selected print data file from among one or more print profiles stored in the mobile device; and
printing the transmitted selected print data file based on the transmitted print profile.

16. The method of claim 15, wherein the one or more print profiles are provided from the image forming apparatus to the mobile device.

17. The method of claim 15, further comprising:
transmitting to an other image forming apparatus the selected print data file and the print profile corresponding to the selected print data file; and
printing the transmitted print data file based on the transmitted print profile by using the other image forming apparatus.

18. The method of claim 15, wherein the mobile device is connectable to the image forming apparatus by a wired and/or a wireless connection.

19. The method of claim 15, wherein each of the one or more print profiles comprises information regarding at least one of ‘document related information’, ‘profile creation date’, ‘print range’, ‘number of copies’, ‘paper size’, ‘pages per sheet (N-up)’, ‘orientation’, ‘margins’, or combinations thereof.

20. The method of claim 15, further comprising displaying on the mobile device the print profile corresponding to the selected print data file and is stored in the mobile device.

21. A mobile device comprising:
a storage unit for storing one or more print data files and one or more print profiles which correspondingly match the one or more print data files;
a user interface for displaying at least some of the one or more print data files and to receive a selection selecting one of the displayed print data files; and
a control unit for transmitting to an image forming apparatus the selected print data file and a print profile corresponding to the selected print data file,
wherein the image forming apparatus prints the transmitted print data file based on the transmitted print profile.

22. An image forming apparatus connectable to mobile apparatuses, the image forming apparatus comprising:
a storage unit storing print profiles that are transmittable to the mobile apparatus;
a user interface to display the stored print profiles;
a communication interface to transmit print profiles to the mobile apparatuses;
a control unit to control the storage unit, the user interface and the communication interface to transmit print profiles to the mobile apparatus and to receive a selected print profile and print data from the mobile apparatus; and
an image forming unit to print the print data from the mobile apparatus according to the selected print profile.

23. The image forming apparatus of claim 22, wherein the user interface also displays user selectable printing options of the print profiles including at least one of ‘document related information’, ‘profile creation date’, ‘print range’, ‘number of copies’, ‘paper size’, ‘pages per sheet (N-up)’, ‘orientation’, ‘margins’, or a combination thereof.

24. The image forming apparatus of claim 22, wherein the storage unit stores the selected print profile according to the mobile apparatus from which the selected print profile was received.
